(19) United States
(12) Patent Application Publication
(10) Pub. No.: US 2006/0123127 A1
(43) Pub. Date: Jun. 8, 2006

(54) System and method for organizing online communities and virtual dwellings within a virtual environment

(75) Inventor: Andrew Littlefield, San Francisco, CA (US)

Correspondence Address: FLIESLER MEYER, LLP, FOUR EMBARCADERO CENTER, SUITE 400, SAN FRANCISCO, CA, 94111, US

(73) Assignee: Evil Twin Studios, Inc., San Francisco, CA (US)

(21) Appl. No.: 11/292,702

(22) Filed: Dec. 2, 2005

Related U.S. Application Data
(60) Provisional application No. 60/634,806, filed on Dec. 8, 2004.

(51) Int. Cl. G06F 15/16

(52) U.S. Cl. 709/229; 709/205

(57) ABSTRACT

A system and method for organizing online communities and virtual dwellings in a virtual environment through the analysis of instant messenger buddy lists, online address books and other user supplied data. The invention is generally related to instant messaging systems, online gaming environments, online communities, and interactive computing, and is specifically related to the organization of online communities and virtual dwellings in a virtual environment through the analysis of Instant Messenger “Buddy Lists”, online address books and other data supplied directly by the user.

### CLAIM OF PRIORITY

This application claim priority to U.S. Provisional Application No. 60/634,806 entitled “System and Method for Organizing Online Communities and Virtual Dwellings Within a Virtual Environment”, by Andrew Littlefield, filed Dec. 8, 2004 [Attorney Docket No. EVTWS-01001 US0].

### CROSS REFERENCES

This application is related to U.S. patent application Ser. No. 11/244,850 entitled “System and Method for Integration of Instant Messaging and Virtual Environment Clients” by Andrew Littlefield, filed Oct. 6, 2005 [Attorney Docket No. EVTWS-01000US1]; U.S. patent application Ser. No ______, entitled “System and Method for Communicating Object status Within a Virtual Environment Using Translucency” by Andrew Littlefield, filed Dec. 2, 2005 [Attorney Docket No. EVTWS-01002US1]; and U.S. patent application Ser. No. ______ entitled “System and Method for Communicating Travel Progress Within a Virtual Environment” by Andrew Littlefield, filed Dec. 2, 2005 [Attorney Docket No. EVTWS-01003US1], all are incorporate herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to instant messaging systems, online gaming environments, online communities, and interactive computing, and is specifically related to the organization of online communities and virtual dwellings in a virtual environment through the analysis of Instant Messenger “Buddy Lists”, online address books and other data supplied directly by the user.

### BACKGROUND

Instant Messaging

In the context of online or distributed computing environments, the use of chatting or instant messaging has existed in one form or another for many years. Early instant messaging systems only allowed users sharing the same computer to synchronously exchange messages. These systems were later expanded to allow users on different computers to exchange messages synchronously via a computer network.

In more recent years there have been a number of projects focused on providing synchronous messaging capabilities across the Internet and it's precursor ARPAnet. Many of these projects only ever supported a handful of users. However a couple of projects such as Bitnet Relay Chat gained user communities numbered in the thousands. Another project, the Internet Relay Chat project (IRC), developed by Jarkko Oikarinen in 1988, was the first widely adopted instant messaging network. This network later grew to support hundreds of thousands of users. The popularity of IRC can be linked to three factors:

Timing: The first release of IRC in 1988 allowed the messaging network, protocols and clients to mature before the Internet boom of the mid 90's, so allowing the network to scale with the incredible upswing in usage that occurred with many Internet based technologies.

Ease of use: Compared to earlier messaging systems, IRC was substantially easier to use than it's precursors

Channel Model: IRC was designed to be part of a Bulletin Board System (BBS) and so supported the then common user model of interest channels. Users could subscribe to a channel and then communicate synchronously with anyone else that had also subscribed to that channel, so enabling group conversations (similar to telephone conference calls). This dramatically expanded the user base of those that would be interested in using such a technology from the then core user group of system administrators (that used messaging to discuss and resolve administrative problems in real time with their colleagues in different locations), to technically savvy Internet users who use IRC to discuss an incredibly broad range of topics.

While the IRC network continued to flourish, in 1996 a group of engineers released ICQ (“I seek you”, an instant messaging product that would soon eclipse the popularity of IRC. Within six months of release ICQ already had over 850,000 users (all through word of mouth) and a network capable of supporting hundreds of thousands of simultaneous users. The popularity of ICQ can be traced to the following factors:

Ease of use: While IRC represented a step forward in terms of ease of use compared to it's predecessors, IRC clients were still comparatively complex and difficult to operate. In contrast the early ICQ clients where very easy to use and well within the scope of complexity that the average computer user can manage.

The “Buddy List”: ICQ introduced a very important innovation to the world of instant messaging though the integration of a stateful list that provided the online status (available, busy, in a meeting, etc) of various contacts that the user had already established and allowed chat sessions to be initiated through simply clicking on a contact name. This innovation, allowed users to determine the status of a user prior to attempting communication and allowed users to initiate conversations with very little overhead.

Peer to Peer Architecture: The ICQ engineers designed the ICQ clients so that they where much less reliant upon a central server or single purpose network to route messages between users. Most of the data traffic associated with ICQ chat sessions occurs between the machines on which the ICQ client is running rather than requiring a central server to route the message traffic (a requirement with IRC). This allowed the ICQ team to increase the number of users that ICQ network could support with only a very minimal incremental investment required in central network resources, so reducing the costs associated with running such a network.

Timing: As with the IRC network, the ICQ team where able to take advantage of the incredible growth in Internet user community during the 1990s. As the ICQ client was so easy to use, adoption was incredibly widespread with instant messaging becoming the #3 Internet traffic driver by 2000 (just behind email) and having surpassed email to become the #2 traffic driver at the time of this writing.

The success of ICQ did not go unnoticed by the “Internet giants” with AOL acquiring ICQ in 1997. Microsoft and Yahoo! also introduced instant messaging clients in 1997. At the time of writing AOL has maintained it's early lead in the IM market with an estimated 60 million registered users. Microsoft and Yahoo! have an estimated 23 million users and 19 million users respectively.

Virtual Environments

A virtual environment is a computer-simulated environment intended for its users to inhabit and interact with via avatars. This habitation usually is represented in the form of two or three-dimensional graphical representations of humanoids (or other graphical or text-based avatars). Some, but not all, virtual worlds allow for multiple users.

The world being simulated typically appears similar to the real world, with real world rules such as gravity, topography, locomotion, real-time, and communication.

The earliest instances of virtual environments can be traced back to 1978, when Roy Trubshaw introduced the first release of the Multi User Dungeon (MUD) program. MUD was purely text based, relied upon textual descriptions of the virtual environments and characters, with users interacting via text commands also. An example of a MUD gaming session is shown in FIG. 1.

MUD allowed multiple users (or game characters) to explore the same virtual world simultaneously. It also allowed characters to interact with each other in various forms ranging from conversation to a fight to the death. Users could interact with environmental objects, in which case the system provided stateful tracking of those objects (e.g. a player can drop a coin in a room, and should another player visit that same room at a later time they will be able to see that same coin object and interact with it). The MUD program also allowed players to create their own virtual environments and game spaces using a built-in scripting language so allowing expansion of the virtual environment by end users. This extensibility coupled with strong game play elements proved to be very popular at the time of release, with several MUD deployments still in use today. More importantly the MUD provided the functional blueprints on which many virtual environments still utilize to this day.

The popularity of the original MUD did not go unnoticed by commercial vendors, who developed the second generation of virtual environments in the mid eighties. This second generation of virtual worlds, leveraged the same text based interaction model and the same basic game play elements as MUD. However this second generation differed from the first in terms of the scale of the virtual environments and the maximum number of simultaneous users that the virtual worlds could support.

This second generation of virtual environments were introduced to the general public in the U.S. and in Europe by the then dominant online providers, including Compuserve, Prestel and CompuNet. These initial commercial offerings proved to be massive initial success in the US where flat rate local phone calls where commonplace so allowing gamers to connect to local POPs with zero incremental costs. However in the UK and most of Europe local telephone calls where charged by the minute, and so resulting in extensive telephone bills. The popularity of these games/virtual environments allowed CompuServe to capture over one million users over a period of three years. Other online services, including AOL soon followed suit and offered similar environments as part of their service offerings. AOL soon rose to become the dominant online service provider in the US and virtual environments remained a major part of the offerings made to users. This resulted in AOL becoming the preeminent distribution channel for virtual world developers as the AOL user base grew to dwarf the other online providers. The reliance upon a single distribution channel left many virtual world developers in a vulnerable position and would eventually cause their demise.

Many of these free virtual environments were running variants of TinyMUD developed by Jim Aspnes at Carnegie Mellon University. TinyMUD was one of the first virtual environments to be ported to the Unix operating system which had become the de facto server OS of choice of Universities and large corporations by the mid nineties. This resulted in just about anyone with reasonable access permissions to a university or corporate server being able to host their own virtual environment for use by their friends and the general public. Such hosting activities were typically pretty short lived as a popular TinyMUD deployment would soon start impact the other work/applications that where being used on the same server, but there was a sufficient number of servers on the Internet that players could always find a new virtual environment to explore and play in.

Commercial virtual worlds found a new lease of life with the introduction of the first generation of Massively Multiplayer Online Games (MMOGs) in 1997 when Origin Systems launched Ultima Online and NCSoft's launched Linage. These two products were based on the world game models as the earlier MUD implementations but extended these models with a rich 3D interaction model. Rather than describing the virtual environments in text, the first generation MMOGs rendered a graphical representation of those environments in an isometric 3D form. Players were represented in a similar manner and rather than having to type “Go North” a player would just press the up arrow on their keyboard and their character or avatar would move or “walk” in real time towards the top of their display screen (e.g. virtual North).

These rich graphic environment made these MMOGs significantly more attractive to the average user who was used to the 3D graphical environments offered by games such as Doom or Quake and the MUD based game model proved to be as compelling as ever. Ultima online garnered 100,000 users within a year, and proved the MUD model could be commercially successful in the new Internet based online marketplace. So the modern MMOG market was born.

Online Communities (Outside of Instant Messaging, MUDs and MMOGs)

Defining community or more precisely what makes up a community is difficult, recently a federal judge at a FCC workshop said “Community is like pornography, I don't know how to define it, but I sure know it when I see it.” For the purposes of this document community is defined as a group of individuals with the following characteristics:

Common Interests

Frequent Interaction

Identification

With online communities extending that definition through the addition of the following characteristic:

Majority of communications occur online

The history of online communities can be traced back to 1975 and the invention of Listservers, which enabled users to be able to send email to an single email address which is then forwarded to predefined list of users. The communication mechanisms first introduced with Listserver are still in use today, with email aliases and email interest groups remaining popular online community tools.

In 1979 there where two technology introductions that jump started the development of online communities: the Computerized Bulletin Board System (CBBS) that was designed primarily for the consumer market, and Usenet developed for research and academic users.

These two technologies evolved along separate evolutionary arcs (although there was some cross pollination in terms of design ideas) that merged in the mid 1990s with the introduction of web based front-ends for both Usenet and Bulletin Board Systems. These web based front-ends made the underlying technology implementation largely irrelevant to the average end user and ushered in a new generation of web-based online community building tools.

Usenet

Use net was introduced in late 1979, shortly after the release of V7 Unix with support for the UUCP (Unix to Unix CoPy) protocol.

Usenet allows uses to post messages to a message groups that can then be viewed by many users via email or a purpose built client application (a newsreader), in this respect it is very similar in operation to Listservers.

However Usenet differs from Listervers in that messages are persisted so that users may view and comment on previously posted messages.

Usenet also differs from Listservers in how messages are distributed. In most Listserver architectures messages are sent directly to individual users.

For example: If the email alias “unix” is hosted on a Listserver in the andrew.com domain and has 10 subscribers in the karyn.com domain, each message sent to the “unix” alias results in 10 messages sent from the andrew.com to the karyn.com domain.

This distribution mechanism is highly inefficient and given the high cost of Internet bandwidth in the late seventies, it was essential that a more efficient distribution mechanism be developed, if such communities where to develop beyond the initial small communities that had developed around ListServer distributions.

The Usenet distribution mechanism utilizes a series of local news servers which act as gateways or caches for message groups. Those servers exchange single copies messages with other news servers on remote networks. This store and forward message architecture dramatically reduces the amount of bandwidth to support any given distribution when compared to ListServer distribution mechanisms.

Initially the Usenet was designed to facilitate the exchange of information within the Unix community, however as the Internet became more widely adopted the number of Usenet topics mushroomed and as of October 2004 there are over 110,000 newsgroups in distribution.

This rise in adoption of Usenet drove significant efforts to ensure that Usenet could scale to support millions of users and hundreds of thousands of topics, it also drove the introduction of Moderated Newsgroups in 1984.

Moderated newsgroups where a response to increasing numbers of new users posting, inappropriate, off topic or massively cross-posted messages (also referred to as “noise” or “Spam”) to newsgroups. Moderated newsgroups allow a designated user (the moderator) to filter messages prior to them being posted to the newsgroup at large. This allowed the moderator to ensure that all postings where on topic and didn't breach the posting rules associated with a particular newsgroup.

In 1986 as part of the ongoing effort to make Usenet more scaleable and efficient, the Network News Transfer Protocol (NNTP) package was introduced as a replacement for UUCP. NNTP also enabled users to connect to a local news server via a remote client running on their local PC, rather than having to log directly onto the news server.

The core Usenet infrastructure has remained relatively stable since the 1980s without any significant additions/improvements outside the area of Usenet clients that have improved significantly in terms of ease of use.

Bulletin Board Systems (BBS)

The first BBS system was developed in 1978 and released to the public in 1979 by Ward Christensen and Randy Suess.

BBS operate like a virtual thumb-tack bulletin board, participants can post messages to a public “board” and others can read and respond to those messages. As usage in message boards expanded, those boards where divided into various topic areas in a similar manner to Usenet groups.

However early BBS systems differed from Usenet in one very important aspect: connectivity. Early BBS systems where standalone entities, they where not connected to other BBS or the Internet. This meant that if a user posted to the Unix bulletin board group on a BBS based in Chicago then only users of that particular BBS could access that message.

There was only limited usage of BBS until 1985 and the introduction of 1200 Bit/Sec modems. Until this time users had been limited to connecting to BBS via 100 and 300 Baud modems that made usage of these services painfully slow.

After 1985 BBS usage blossomed, with thousands of BBS popping up all over the globe, although the flat-rate local call billing structure in place in the US meant that a majority of BBS deployments occurred in this geography.

As adoption grew, BBS software extended to allow networks of BBS to be built, allowing users from disparate BBS to exchange posts and email. The largest BBS network was Fidonet, which is still widely used outside of the United States. Some BBS systems also provided gateways to Internet mail and Usenet groups as the Internet became more widely adopted.

However as the Internet (specifically the Web) grew in scope and popularity, many BBS operators found it increasingly difficult to compete with the range of content and connectivity options that a direct internet connection could provide and had to change their business model to support direct internet connectivity as part of their offering or perish. Most BBS operations perished, however there where notable exceptions such as America Online that started as an Apple focused BBS.

Other smaller BBS players also managed to change their business model so that their offerings would work in a new Internet market. The Well and Echo NYC both well-regarded BBS have successfully moved their BBS businesses to a subscription fee based model that in which users pay a monthly fee to access the discussion forums hosted by these services.

Web Based Communities

Since the mid-1990s the web has proven to be the most popular platform for the delivery of online community tools.

Early developers of web based community tools initially focused on enabling end-users to publish information to the web. Geocities was a pioneer in this space, that was started in 1995 under the name of The Beverly Hills Internet Service. The original site included a webcam view of Hollywood. By the end of 1995 the sites founder, David Bohnett, had the idea for a collection of “cyber-cities”. A press release at the time said:

“The homesteading program enables anyone with access to the Internet to have a free Personal Home Page, or GeoPage, within our cityscapes”, Mr. Bohnett said. “Because GeoCities are nurtured by communication and sustained by commerce, we are developing new media to endow GeoCities with a rich sense of community, place and interactivity, and also originating new ways to measure our audiences for advertisers,” he said. “This is the next wave of the net—not just information but habitation.”

Geocities proved to be a huge success and was acquired in 1999 it by Yahoo!

Elsewhere developers focused on providing web based replacements for Usenet and BBS functionality. There are now hundreds of off the shelf products available that match the functionality offered by Usenet and BBS (however few systems can match the scalability of Usenet).

There are two market leaders in this space, ezboard focused of meeting general consumer needs with 14 million users and sourceforge focusing on the developer community with 1 million users.

In addition to providing personal publishing tools and replication of existing online community tools, the web platform also provided a fertile breeding ground for new online community tools. The most influential of those over the last decade are as follows:

Blog publishing

Wiki sites

Social network development sites

Blog Publishing

A Blog (weB LOG) is basically just a journal that is published on the web. Blogs are typically updated daily using software that allows people with little or no technical background to update and maintain the blog. Postings on a blog are almost always arranged in chronological order with the most recent additions featured most prominently.

Blogs have been around since the advent of the web; in fact the first ever webpage was a Blog entry from Tim Berners-Lee at CERN (the inventor of the web) in 1992. However Blogs remained in the domain technical publishing until 1999, when new client software packages made Blog publishing simple enough for average users. Since then Blog publishing has becoming increasingly popular with over 500,000 Blogs currently being published on the Web. Many Blog sites allow users to comment on the blog entries so forming a discussion forum around which many small online communities are based.

Wiki Collaboration

A wiki is a Web site comprised of the perpetual collective work of many authors. Similar to a blog in structure and logic, a wiki extends this model by allowing anyone to edit, delete or modify content that has been placed on the Web site using a browser interface, including the work of previous authors. The term wiki typically refers to either the Web site or the software used to create the site.

Ward Cunnigham created the first wiki in 1995, and since then there have been numerous packages developed to support wiki deployments with the most popular being UseMod wiki, TWiki and the Wikipedia software.

Today the English language version of Wikipedia, an online encyclopedia is the worlds largest Wiki by a substantial margin. The second largest wiki, however, is Susning.nu, a Swedish language knowledge base, running the UseMod software.

Social Networking Sites

2002 saw the immergence of a new online community tool category, social networking sites. Products in this new category made explicit a common usage pattern associated with existing online community environments, which allowed users to leverage their connections within an online community to build out their own social network.

These sites store numerous lists of end-user contacts and their associated interests or professional affiliations (as supplied by the user). These lists are then analyzed in aggregate to identify common contacts shared between various users. These common contacts allow the analysis software to map the shape and extent of a users social network and the bridge nodes (users that act as a connection point) between various social networks. This mapping information is then used to allow users to search an extended social network (typically limited to friends of friends) for other users that meet specific criteria for example, a job seekers or users with a particular hobby or interest.

There are a multitude social networking sites targeting various uses of an extended social network. Two of the most popular social networking sites reside at opposite ends of the usage spectrum; with Friendster encouraging the development of an extended social network in which users can find new friends, and with LinkedIn focusing on the development of a professional social network that will help users find new employment, recommend job candidates and business partners.

### SUMMARY

The invention is generally related to instant messaging systems, online gaming environments, online communities, and interactive computing, and is specifically related to the organization of online communities and virtual dwellings in a virtual environment through the analysis of Instant Messenger “Buddy Lists”, online address books and data supplied directly by the user.

An objective of the present invention is to distribute users virtual dwellings inside a virtual environment in such a manner that encourages the development of online communities. Another objective of the present invention is to provide an access model associated with the virtual environment that allows users to congregate with their peers without the intrusion of users outside of that peer group. Another objective of the present invention is to provide a privacy model that allows users while interacting with users inside their peer group to provide personal information that will allow further communications outside of the virtual environment or establish areas of common interest while protecting that same personal information from users outside of their peer group. The core functionality includes the analysis of user IM buddy lists to develop a model of their social network and common touch points with the social networks associated with other users. These models are then applied to the organization of virtual dwellings and the security and privacy models associated with those users.

### BRIEF DESCRIPTION OF THE DRAWINGS

FIG. 1 shows an illustration of an example of a MUD text-based gaming session.

FIG. 2 shows a graph representing a simple social network.

FIG. 3 shows the application of social network analysis to place virtual dwellings inside a virtual environment.

FIG. 4 shows a flowchart demonstrating the control logic associated with a waterfall permissions model.

FIG. 5 shows the application of invention access control and privacy model to a virtual environment.

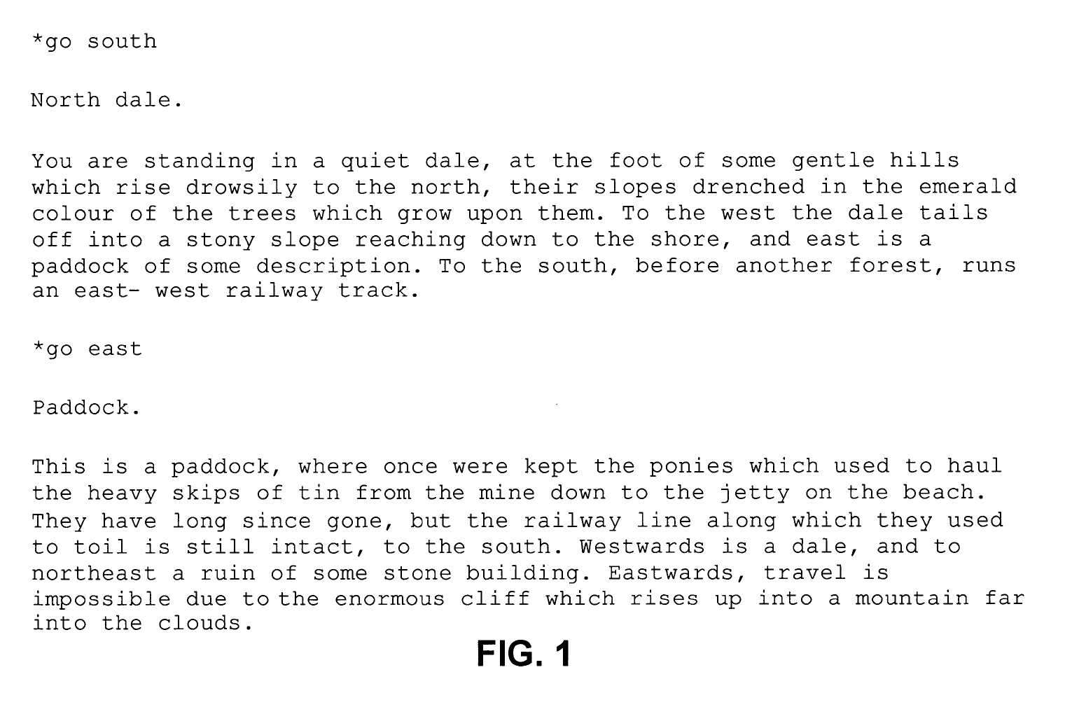

### DETAILED DESCRIPTION

Organization

The virtual environment is organized through placement of users virtual dwellings so that they are located close proximity to the virtual dwellings associated with their circle of friends or peer group. Such placement of virtual dwellings encourages a high degree of interaction between those users, by leveraging users prior real-world experiences associated with establishing and maintaining friendships. Such friendships are highly influenced by proximity (Nahemow. L. & Lawton, M. P. (1975). Similarity and propinquity in friendship formation. Journal of Personality and Social Psychology, 33, 205-213).

An example of this influence was documented in the article: Alphabet and attraction: An unobtrusive measure of the effect of propinquity in a field setting, written by M. W. Segal published in the Journal of Personality and Social Psychology in 1974. It was observed that in high-school classes where seating was assigned on an alphabetical basis, many groups of high school students there was a high incidence of friends with surnames that start with the same letter of the alphabet.

Circles of friends are identified through the analysis of end-users buddy lists, online address books or names of friends/peers provided directly by the end-user. These data sources are cross-correlated with the buddy lists and address books from other users, so that the system can identify users that share many common friends and place those users in the same building or neighborhood.

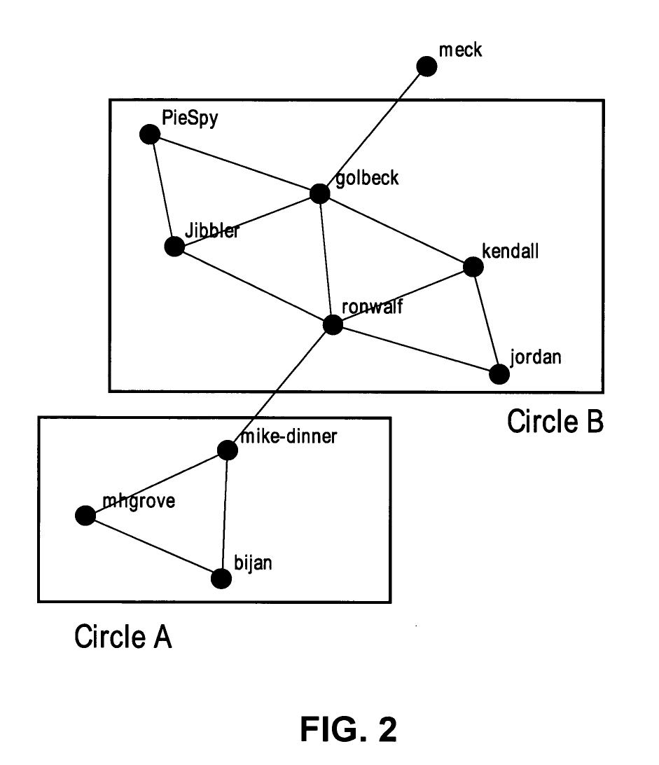

In FIG. 2, a simple social network is represented in graph form. This graph consists of a set of nodes and edges, where each node represents an IM user and an edge represents buddy list entries that indicates a link between the two social networks

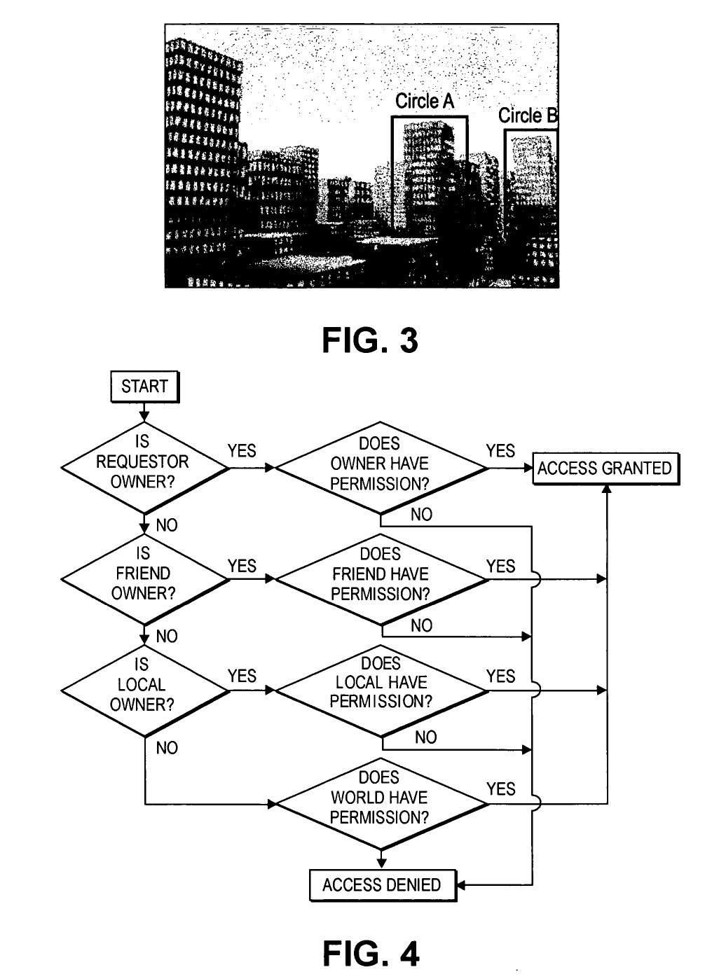

The graph in FIG. 2 represents two circles of friends (A and B), and those circles of friends have been used to place users in those circles in the same virtual buildings as shown in FIG. 3. It's important to note that the two circles of friends have been placed in the same neighborhood due to the social network links between users in the two networks, had there been more links between the two circles of friends then the two circles of friends would have been placed in closer proximity (potentially in the same building)

The analysis of users social networks can also used to drive virtual environment facilities made available to users, location of building inside the environment and access permissions associated with environmental objects.

Virtual Dwelling Organization Use Case

A virtual environment has been deployed that using a world model based on a modern western city. Users are placed in either a high-density dwellings or low-density neighborhoods based on the density and size of their social network. Users with large (as determined by their buddy list size) and dense (as determined by the overlap of their buddy list with others) social networks will be placed in virtual buildings that would support high-density housing in the real world (such as a tower block). Users with small or low-density social networks will be placed in virtual buildings that would support low-density housing (such as single family house).

The placement of buildings inside the virtual environment is also driven by the size and density of social networks, with buildings that house users with large and/or dense social networks being placed close to the center of the city and buildings that house users with smaller and low density social networks towards the edge of the city. This organizational mechanism when used in conjunction with the neighborhood organizational mechanisms that place linked circles of friends in the same neighborhood creates city skylines and city geographies that is very similar to those in most western cities in which the center of the city contains greater housing density and the edge of the city contains lower density housing that makes up the suburbs.

The size and density of users social networks alsos drives the placement and availability of virtual environment facilities such as virtual sports bars, casinos, singles bars, and homework lounges.

These facilities are allocated on a per-capita basis, so users in areas of dense virtual dwellings will have more facilities available to them in a two block radius of their virtual dwelling when compared to those users in areas of lower density virtual dwellings. This creates an environment that has a very similar “feel” to most cities, as very similar economic rules drive the distribution of such facilities inside real-world cities.

Access Control and Privacy Model

The access permissions and security model associated with the invention is similar to the waterfall permissions model (see FIG. 4) used in most modern operating systems.

There might be four user categories associated with access permissions in the present invention: owner, friend, local and world.

The user category is used in exactly the same way as in the UNIX operating system and defines a single user who owns a particular resource. The friend user category is defined in relation to the owner of the file, and contains users that are listed on that users IM buddy list in the friend category. The local user category consists of friends of friends, as determined through the analysis of the buddy lists of users that appear in the friend category of the original user.

The world category consists of all users that are not covered by the user, friend or local categories.

These user categories are used to control access permissions and the privacy model associated with all objects and environments inside the virtual environment.

The privacy model associated with the invention also allows users to define the communication medium and level of anonymity based these same categories.

The privacy model associated with this invention is intended to mirror real world environments as closely as possible. Users can move around inside the virtual environment in relative anonymity with the users identity (IM account) only made available to users in the friend and local categories. This prevents harassment of users when they leave the virtual environment by maintaining their anonymity with all users in the world category.

This privacy model is also used to limit the communication channels through which users can communicate. A users can configure their virtual environment clients so that users in the friend category can communicate via video conferencing and local and world users are limited to text conversations. This text communication channel can be filtered to prevent profanities and obscenities from being received by users if they wish.

This access control mechanism coupled with the distribution of environmental facilities inside a virtual environment based on the present invention is designed to reduce the level of conversational “noise” typically associated with online communities.

The term “noise” is often used to describe off topic or inappropriate comments or postings to public Internet forums. Excessive “noise” is the most often sighted reason for users no longer participating in or reading public Internet forums that is commonly associated with public Internet forums.

Access Control and Privacy Use Case

This use case builds on the scenario as described in: Virtual Dwelling

Organization Use Case

As noted in the Virtual Dwelling Organization Use Case, environmental facilities (such as a virtual Sports Bar) are distributed on a per capita basis so that all users have such facilities in reasonably close proximity to their virtual dwellings. However access to these local facilities will differ dramatically based on a users social network and their placement inside the virtual environment.

The default access control policies associated with the virtual facilities are designed to make them as private as possible. When the catchments area associated with an environmental facility is made up of virtual dwellings with owners that in the majority share a mutual local or friend status then the access permissions associated with that facility will be set so that only users in those groups can enter. If a majority of users isn't present in a catchments area then the environment facility is opened up to the world groups.

This access control mechanism provides users with rich social networks access various semi-private meeting spaces or chat forums that will be solely populated with their friends or friends of friends, so reducing the noise in these forums, as there are real-world social consequences associated with any forum inappropriate behavior or comments. This grouping of friends and friends of friends also improves the likelihood that users will find themselves conducting conversations with other users with similar interests or backgrounds, so making their interactions more enjoyable or profitable.

Semi-Private Virtual Meeting Spaces Usage Cases:

Homework room for teens in the same class at school.

Coffee Shop where a group of teenage girlfriends can gossip without the intrusion of their male schoolmates.

Coffee Shop with public notice board for alumni of a particular collage class to network and discuss new employment leads and opportunity.

Sports Bar where alumni of a specific fraternity at a college can discuss collage football and generally “hang out”

Skateboard half-pipe where a group of high school friends can chat with each other after their curfew.

Strip club with virtual non-player-character strippers where a group of male junior collage friends can chat.

Coffee shop where gay students of several high schools can socialize.

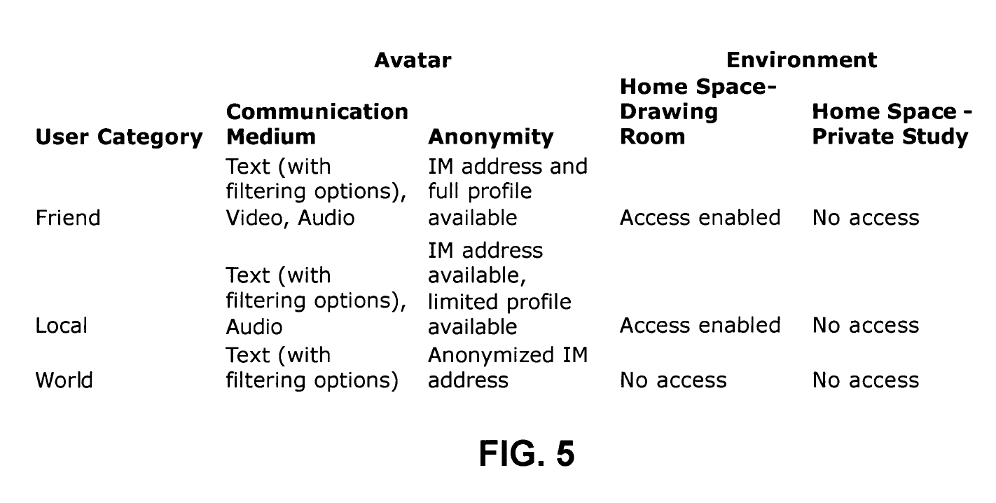

Example access control and privacy settings associated with this use case can be seen in FIG. 5.

Implementation Strategy

Our basic problem is to identify clusters in a general user graph where the links indicate mutual membership in “buddy lists.” This problem has the following parameters: G the graph of users in the system and D the maximum distance each user in a building can be from the building's anchor user or hub. The solution should assign users to buildings such that the connectivity within the building's users is maximized while the connectivity of users between buildings is minimized (Property 1). For each connected group in the graph (i.e. circle of friends) a clustering algorithm (Algorithm 1) will be called that produces the set of clusters satisfying Property 1. As new users connect into the network they will be assigned a building or cluster depending on current connectivity or assigned temporary space in a building with singleton users.

The second part of the problem is updating building assignments based on changes in link patterns between users. If a user loses all connectivity to his fellow building residents then they are moved to a new building. However, the initial clustering strategy will assign each user to buildings in which they have the most connectivity and least chance of being moved.

### REFERENCES FOR THE GRAPH CLUSTERING ALGORITHMS

http://www.mondeca.com/english3/published-doc/GraphClusteringforVeryLarg eTopicMaps.htm
http://www.cs.nyu.edu/cs/faculty/shasha/papers/GraphClust.html

### INDUSTRIAL APPLICABILITY

Advantages provided by the invention include: the distribution users virtual dwellings inside a virtual environment in such a manner that encourages and accelerates the development of online communities and friendships; an access model associated with the virtual environment that allows users to congregate with their peers without the intrusion of users outside of that peer group; a privacy model that allows users while interacting with users inside their peer group to provide personal information that will allow further communication outside of the virtual environment or establish areas of common interest while protecting that same personal information from users outside of their peer group; an access control model that reduces conversational “noise” that is typically associated with online forums; an privacy model that allows users to control the communication channels through which users can contact them based previous social interactions and familiarity.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD ROMs, microdrive, and magneto optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for providing online communities, comprising:
a virtual environment;
a plurality of virtual communities or dwellings within said virtual environment, for holding or being otherwise made available to virtual representations of users;
wherein the virtual communities, dwellings, and representations of users are placed in the virtual environment according to community groupings as determined through social network analysis; and
wherein the community groupings are determined by an analysis of buddy lists, online address books, lists of user names, or other data about users, as provided by a user of the virtual environment.

2. A method for providing online communities, comprising the steps of:
providing a virtual environment;
determining community groupings by an analysis of buddy lists, online address books, lists of user names, or other data about users, as provided by a user of the virtual environment; and
providing a plurality of virtual communities or dwellings within said virtual environment, for holding or being otherwise made available to virtual representations of users, wherein the virtual communities, dwellings, and representations of users are placed in the virtual environment according to the community groupings as determined through social network analysis.
